(19) United States
(12) Patent Application Publication
(10) Pub. No.: US 2026/0337406 A1
(43) Pub. Date: Oct. 29, 2026

(54) High-rebound molded polyurethane foam with gradient hardness and method for preparing same

(71) Applicant: Adient US LLC, Plymouth, MI (US)

(72) Inventors: Haiou DENG, Shanghai (CN); Lucas ZHANG, Shanghai (CN); Haifeng NI, Shanghai (CN)

(73) Assignee: Adient US LLC, Plymouth, MI (US)

(21) Appl. No.: 19/657,381

(22) Filed: Apr. 24, 2026

(30) Foreign Application Priority Data
Apr. 28, 2025 (CN) 202510549324.9

(51) Int. Cl. C08L 75/08; C08J 9/00; C08J 9/12

(52) U.S. Cl. CPC C08L 75/08; C08J 9/0061; C08J 9/125; C08J 2203/10; C08J 2205/048; C08J 2205/05; C08J 2375/08; C08J 2483/04; C08L 2203/14; C08L 2207/324

(57) ABSTRACT

The present disclosure includes a high-rebound molded polyurethane foam with gradient hardness from an upper surface to a lower surface. The high-rebound molded polyurethane foam has uniform density within a thickness from the upper surface to the lower surface, and the high-rebound molded polyurethane foam has a sag factor greater than 3.0, the sag factor being the ratio of 65% compression hardness value to 25% compression hardness value. The present disclosure also includes a method for preparing a high-rebound molded polyurethane foam.

### FIELD

The present application relates to a high-rebound molded polyurethane foam, in particular to a high-rebound molded polyurethane foam with gradient hardness.

### BACKGROUND

In a conventional high-rebound molded polyurethane foam, hardness is uniform from top to bottom. To improve comfort, one or more layers of soft high-rebound molded polyurethane foam are generally bonded to an upper surface. This means that more material and manpower costs are required.

Furthermore, in the prior art, gradient hardness of high-rebound molded polyurethane foam can be achieved through a difference in density between upper and lower regions, for example, (pages 1-5 of the Description) mentioned in patent document US20240109467A1.

### SUMMARY

To solve the above problem, the present application provides a high-rebound molded polyurethane foam with gradient hardness and uniform density.

A first aspect of the present application provides a high-rebound molded polyurethane foam with gradient hardness from an upper surface to a lower surface, wherein the high-rebound molded polyurethane foam has uniform density within a thickness from the upper surface to the lower surface, and the high-rebound molded polyurethane foam has a sag factor greater than 3.0, the sag factor being the ratio of 65% compression hardness value to 25% compression hardness value.

Another aspect of the present application provides a method for preparing the high-rebound molded polyurethane foam with gradient hardness described above.

Unlike the prior art, the high-rebound molded polyurethane foam provided in the present application is an integral whole having continuous hardness variation, with low hardness at the top and high hardness at the bottom, and also has uniform density within the range of thickness from the top to the bottom. Unexpectedly, the high-rebound molded polyurethane foam of the present application has a high sag factor, and thus offers excellent comfort. The gradient hardness of the high-rebound molded polyurethane foam of the present application is achieved by improving the pore structure of the high-rebound molded polyurethane foam; this is different from gradient hardness provided by changing density. The present invention not only ensures that the high-rebound molded polyurethane foam is integrally formed, considerably reducing process complexity and labor costs, but also retains the characteristic of the high-rebound molded polyurethane foam in having uniform density from top to bottom. This means that there is no significant difference in physical performance between different positions, so the service life of the high-rebound molded polyurethane foam can be increased.

### BRIEF DESCRIPTION OF THE DRAWINGS

Embodiments of the present invention will now be described through examples with reference to the drawings.

FIG. 1 shows a structural schematic drawing of the high-rebound molded polyurethane foam according to embodiments of the present application.

FIG. 2A shows scanning electron microscope (SEM) result pictures of foam of formulation 1 according to the present application.

FIG. 2B shows scanning electron microscope (SEM) result pictures of foam of formulation 1 according to the present application.

FIG. 2C shows scanning electron microscope (SEM) result pictures of a standard reference foam.

FIG. 2D shows scanning electron microscope (SEM) result pictures of a standard reference foam.

FIG. 3 shows a schematic drawing of a hardness test according to embodiments of the present application.

### DETAILED DESCRIPTION

A first aspect of the present application provides a high-rebound molded polyurethane foam 10 with gradient hardness from an upper surface 20 to a lower surface 30, wherein the high-rebound molded polyurethane foam 10 has uniform density within a thickness from the upper surface 20 to the lower surface 30, and the high-rebound molded polyurethane foam 10 has a sag factor greater than 3.0, the sag factor being the ratio of 65% compression hardness value to 25% compression hardness value.

The term “high-rebound” means that the foam 10 has a ball rebound ratio ≥60%. The ball rebound ratio is tested according to standard GBT-6670-2008.

Sag factor (SF): Ratio of 65% compression hardness value (ILD65) to 25% compression hardness value (ILD25) in a hardness test (GB/T 10807) of the high-rebound molded polyurethane foam:

$$Sag Factor = \frac{ILD 65}{ILD 25}$$

The sag factor can reflect the supported load of the high-rebound molded polyurethane foam 10. It is generally considered that an SF greater than 2.8 means an average comfort requirement, while an SF greater than 3.0 means excellent comfort performance. In some embodiments, the foam 10 of the present invention may have an SF value of up to 3.2, even 3.3.

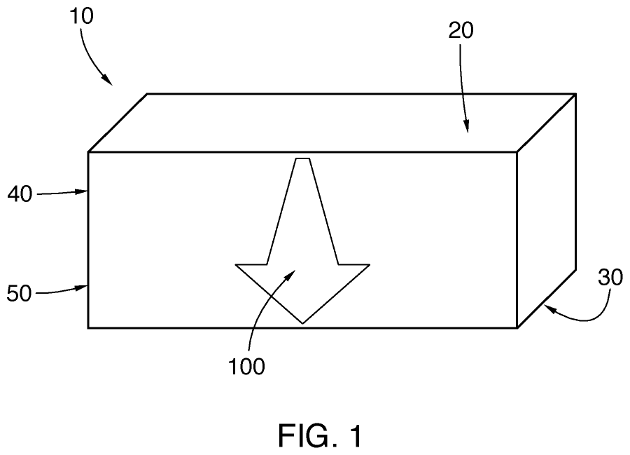

As shown in FIG. 1, the high-rebound molded polyurethane foam 10 of the present application has an upper surface 20 (also known as a top 20 and position 1) and a lower surface 30 (also known as a bottom 30 and position 4), and has continuously increasing hardness in a direction from the upper surface 20 to the lower surface 30 as shown by the arrow 100 in FIG. 1. For example, the hardness at the top 20 of the high-rebound molded polyurethane foam 10 is lower than the hardness at the bottom 30 thereof (hardness: position 1 20<position 2 40<position 3 50<position 4 30), but the density within the overall thickness range shows essentially no variation. In embodiments, position 1 (20) is located at approximately ⅕ of the total thickness of the high-rebound molded polyurethane foam 10 in the direction from the upper surface 20 to the lower surface 30. Position 2 40 is located at approximately ⅖ of the total thickness of the high-rebound molded polyurethane foam 10 in the direction from the upper surface 20 to the lower surface 30. Position 3 50 is located at approximately ⅗ of the total thickness of the high-rebound molded polyurethane foam 10 in the direction from the upper surface 20 to the lower surface 30. Position 4 30 is located at approximately ⅘ of the total thickness of the high-rebound molded polyurethane foam 10 in the direction from the upper surface 20 to the lower surface 30.

In some embodiments, the high-rebound molded polyurethane foam 10 is prepared from a formulation comprising modified diphenylmethane diisocyanate (modified MDI) and a white material component. The white material component comprises a polyol with a molecular weight of 4000-7000 MW and an associated aid. Specifically, the high-rebound molded polyurethane foam is prepared from modified MDI with an NCO value of 10-33.6 and a polyol with a molecular weight of 4000-7000 MW. A polyol with low molecular weight and high functionality, and a polyol with high molecular weight and low functionality are preferred, to increase the difference in reactivity between the different polyols. In some embodiments, the ratio of modified MDI to white material in the formulation is 45-60:100 (weight percentage), and the amount of modified MDI used can be adjusted in real time according to product requirements. For example, the ratio of modified MDI to white material may be 45:100, 50:100, 55:100, etc.

In some embodiments, the white material component comprises a catalyst, a chain extender, a silicone oil and a cell-opening agent and water, or the white material consists of a catalyst, a chain extender, a silicone oil and a cell-opening agent and water.

In some embodiments, the polyol is a mixture of polyether polyols.

In some embodiments, the mixture of polyether polyols comprises two or more different conventional polyether polyols selected from Dongda DEP-5631 D, DEP-3500D, EP-330N and EP-3600 and Wanhua F3128, F3135, F3156 and F3170A. For example, the mixture of polyether polyols may comprise any one of the following combinations: DEP-5631D and F3128; EP-330N and F3156; DEP-5631D and EP-330N; DEP-3500D and EP-3600; DEP-5631D, F3170A and EP-330N; DEP-3500D, EP-330N and F3156; DEP-5631D, F3135 and EP-3600; F3128, EP-3500D and F3170A, etc. It was unexpectedly discovered in the present application that the use of the mixture of polyether polyols mentioned above can effectively improve a hardness characteristic of the high-rebound molded polyurethane foam 10, thereby achieving a favorable sag factor (greater than 3.0).

In some embodiments, the mixture of polyether polyols may further comprise a grafted polyether polyol, such as Wanhua Chemical F2140.

In some embodiments, the formulation used to prepare the high-rebound molded polyurethane foam comprises a mixture of polyether polyols, the mixture of polyether polyols comprising a conventional polyether polyol and a grafted polyether polyol or consisting of a conventional polyether polyol and a grafted polyether polyol. The formulation used to prepare the high-rebound molded polyurethane foam may comprise 50 wt %-85 wt % of a conventional polyether polyol and 1 wt %-50 wt % of a grafted polyether polyol. For example, the formulation may comprise 50 wt %, 52 wt %, 55 wt %, 60 wt %, 62 wt %, 70 wt %, 72 wt %, 80 wt %, 82 wt % or 85 wt % of a conventional polyether polyol. The formulation may further comprise 1 wt %, 5 wt %, 10 wt %, 15 wt %, 20 wt %, 30 wt %, 40 wt % or 50 wt % of a grafted polyether polyol.

Since the polyether polyols have different molecular weights and ethylene oxide (EO) contents, they differ in their reactivity with modified MDI, and the size of the foam 10 formed by reaction is different at the upper 20 and lower surfaces 30, with the cells 70a, 70b at the lower surface 30 being more regular. A polyether with high reactivity such as DEP-5631 D will preferentially react with the modified MDI and be at the lower surface 30 of the high-rebound molded polyurethane foam 10, while a polyether with low molecular weight and high functionality will provide higher strength to the high-rebound molded polyurethane foam 10. As the high-rebound molded polyurethane foam 10 continuously rises and expands, a polyether with low reactivity such as EP-3600 will gradually be deposited in the reaction at the top 20. However, this is not the absolute sequence; it is merely the case that a polyether with high reactivity that preferentially reacts with the modified MDI is present in a higher proportion. Therefore, it is believed that when the reaction of the high-rebound molded polyurethane foam 10 is complete, the overall density of the high-rebound molded polyurethane foam 10 will not vary. This is attributed to the double effect of the molecular weight of the polyether and the cross-linked density of the high-rebound molded polyurethane foam 10. However, the structure of the high-rebound molded polyurethane foam 10 varies from top 20 to bottom 30; in terms of macroscopic structure, the high-rebound molded polyurethane foam 10 has a hardness gradient. Thus, the comfort curve high-rebound molded polyurethane foam 10 provided in the present application exhibits gradient hardness and a high sag factor.

In some embodiments, the upper surface 20 and lower surface 30 of the high-rebound molded polyurethane foam 10 according to the present invention have large cells 60a, 70a, and small cells 60b, 70b respectively, wherein the diameter of large cells 60a at the upper surface 20 is greater than the diameter of large cells 70a at the lower surface 30, and small cells 60b, 70b of both have substantially the same diameter. For example, the diameter of large cells 60a at the upper surface 20 is 2.7 mm-3.0 mm, and the diameter of large cells 70a at the lower surface is 1.5 mm-2.4 mm; small cells 60b, 70b have a diameter less than 0.9 mm, e.g. a diameter of 0.5-0.8 mm.

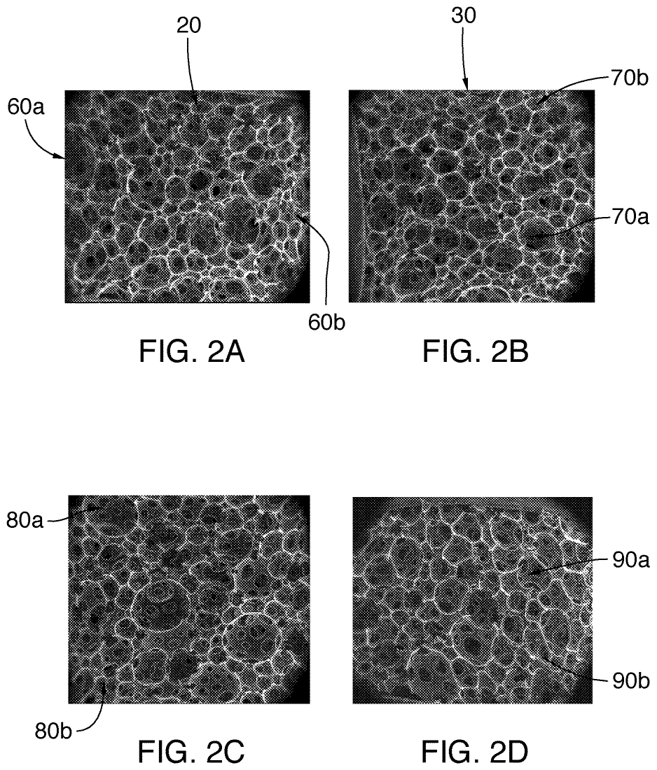

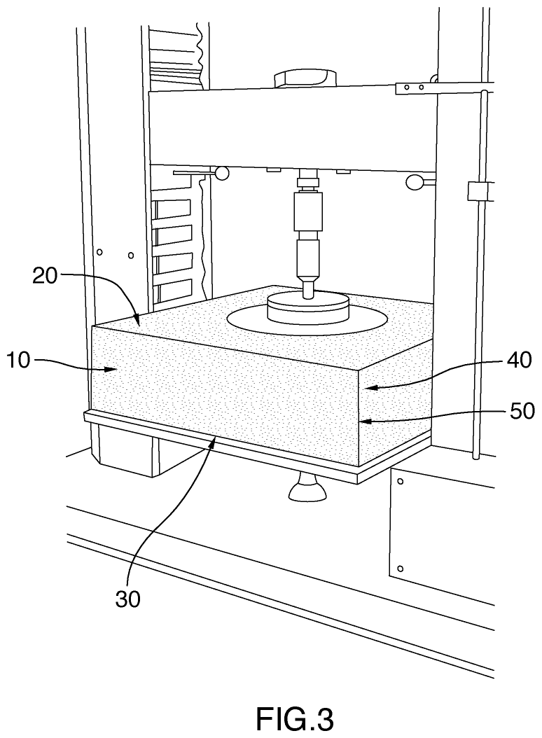

As shown in FIGS. 2A and 2B, the shape of cells 60a, 60b at the upper surface 20 (FIG. 2A) of foam 10 of a formulation 1 according to the present invention is mostly round, wherein the diameter of small cells 60b is 0.54-0.81 mm, and the diameter of large cells 60a is 2.70-2.97 mm; the shape of cells 70a, 70b at the lower surface 30 (FIG. 2B) of foam 10 of a formulation 1 according to the present invention is mostly regular hexagonal (regular crystal orientation), wherein the diameter of small cells 70b is 0.54-0.81 mm, and the diameter of large cells 70a is 1.89-2.43 mm. In comparison, there is no obvious difference in the diameter of cells between the upper and lower surfaces of a conventional foam in the prior art. As shown in FIG. 2C-2D, the shape of cells 80a, 80b at the upper surface (FIG. 2C) of a standard reference molded polyurethane foam is purely round, wherein the diameter of small cells 80b, 90b is 1.08-1.62 mm, and the diameter of large cells 80a, 90a is 2.43-3.51 mm; the shape 90a, 90b of cells at the lower surface 30 (FIG. 2D) of a standard reference molded polyurethane foam is mostly round, and locally regular hexagonal, wherein the diameter of small cells 80b, 90b is 1.08-1.62 mm, and the diameter of large cells 80a, 90a is 2.43-3.78 mm.

In some embodiments, the high-rebound molded polyurethane foam 10 according to the present invention has a density of 70 kg/m³-80 kg/m³ as measured according to GB/T 6343. For example, the foam 10 according to the present invention may have a density of 75 kg/m³ within the range of its thickness.

Another aspect of the present application provides a method for preparing the high-rebound molded polyurethane foam 10 with gradient hardness described above.

In some embodiments, the method for preparing the high-rebound molded polyurethane foam 10 may use 0.1 wt %-3 wt % of a catalyst. For example, it may use 0.5 wt %, 1 wt %, 1.5 wt %, 2 wt % or 2.5 wt % of a catalyst.

In some embodiments, the method for preparing the high-rebound molded polyurethane foam 10 may use 0.1 wt %-3 wt % of a chain extender. For example, it may use 0.5 wt %, 1 wt %, 1.5 wt %, 2 wt % or 2.5 wt % of a chain extender.

In some embodiments, the method for preparing the high-rebound molded polyurethane foam 10 may use 0.1 wt %-3 wt % of a silicone oil. For example, it may use 0.5 wt %, 1 wt %, 1.5 wt %, 2 wt % or 2.5 wt % of a silicone oil.

In some embodiments, the method for preparing the high-rebound molded polyurethane foam 10 may use 0.5 wt %-5 wt % of water. For example, it may use 0.5 wt %, 1 wt %, 1.5 wt %, 2 wt %, 2.5 wt %, 3 wt %, 3.5 wt %, 4 wt % or 4.5 wt % of water.

In some embodiments, the method for preparing the high-rebound molded polyurethane foam 10 uses 0.1 wt %-5 wt % of a cell-opening agent. For example, it may use 0.5 wt %, 1 wt %, 1.5 wt %, 2 wt %, 2.5 wt %, 3 wt %, 3.5 wt %, 4 wt % or 4.5 wt % of a cell-opening agent.

In some embodiments, the method for preparing the high-rebound molded polyurethane foam 10 comprises the following steps:
1) mixing a white material component and stirring (e.g. at 1000-2000 r/min) for 5-10 min;
3) leaving the white material to stand (e.g. for 10-30 min) to eliminate mechanical bubbles caused by mechanical stirring;
4) heating a foam mold (e.g. to 50-70 °C) and applying a mold release agent;
5) quickly pouring a suitable amount of modified MDI into a container containing the white material, stirring (e.g. mechanically at 1000-5000 r/min for 5-20 s), then quickly pouring the mixture into the mold, closing the mold and reacting for a period of time (e.g. 3-6 min);
6) when the reaction is complete, cell opening is completed as quickly as possible to obtain a finished product.

### Example 1

This Example uses the materials in Table 1 below to prepare a high-rebound molded polyurethane foam 10:

TABLE 1
Polyol - white material

| Starting material | Usage amount/wt % |
|---|---|
| Polyether polyol | 50-85% |
| Grafted polyether | 1-50% |
| polyol | |
| Catalyst | 0.1-3% |
| Chain extender | 0.1-3% |
| Silicone oil | 0.1-5% |
| Water | 0.5-5% |
| Cell-opening agent | 0.1-5% |
| Modified MDI | 45-60% of total weight of |
| | white material |

Exemplary description of product preparation process:
1) Preferentially in accordance with the usage amounts in Table 1, the various starting materials are accurately weighed into a beaker, to give 1000 g of white material in total;
2) the white material is mechanically stirred evenly at 1000-2000 r/min for 5-10 min;
3) the white material is left to stand for 10-30 m to eliminate mechanical bubbles caused by the mechanical stirring;
4) a conventional foam mold is chosen; as an example for experiment, a 400*400*100 mm square mold is used, heated to 50-70 °C, and coated with a mold release agent;
5) 500 g of modified MDI is weighed out, and quickly poured into the beaker containing the white material; after mechanically stirring at 1000-5000 r/min for 5-20 s, the mixed material is quickly poured into the mold, the mold is closed and a reaction is carried out for 3-6 m;
6) when the reaction is complete, the mold is opened and a high-rebound molded polyurethane foam 10 is taken out, and cell opening is completed as quickly as possible to obtain a finished product.

TABLE 2
Usage amounts of starting materials of different
formulations according to the present invention

| | Formulation | Formulation | Formulation |
|---|---|---|---|
| Starting material | 1/wt % | 2/wt % | 3/wt % |
| Conventional | 62% | 72% | 52% |
| polyether polyol | | | |
| mixture | | | |
| Grafted polyether | 30% | 20% | 40% |
| polyol | | | |
| Catalyst | 0.65% | 0.65% | 0.65% |
| Chain extender | 1.15% | 1.15% | 1.15% |
| Silicone oil | 0.7% | 0.7% | 0.7% |
| Water | 2.5% | 2.5% | 2.5% |
| Cell-opening agent | 3% | 3% | 3% |
| Modified MDI | 50% | 40% | 45% |

The standard reference is a conventional molded polyurethane foam, which lacks the gradient hardness of the high-rebound molded polyurethane foam according to the present invention. The specific starting materials and usage amounts are as follows:

TABLE 3
Usage amounts of starting materials of standard
reference molded polyurethane foam

| Starting material | Standard reference/wt % |
|---|---|
| Conventional | 62% |
| polyether polyol | |
| Grafted polyether | 30% |
| polyol | |
| Catalyst | 0.65% |
| Chain extender | 1.15% |
| Silicone oil | 0.7% |
| Water | 2.5% |
| Cell-opening agent | 3% |
| MDI | 50% |

The polyether polyol used in the standard reference molded polyurethane foam is EP-330N; it does not comprise any other polyether polyol, and uses MDI. The other materials do not differ significantly from the materials used in the high-rebound molded polyurethane foam 10 of the present invention.

The high-rebound molded polyurethane foam 10 (400*400*100 mm square foam of thickness 100 mm) prepared using the above materials and method was subjected to performance testing, and the results are shown in Table 4 below:

TABLE 4

| | Standard | Formulation | Formulation | Formulation | |
|---|---|---|---|---|---|
| Performance | reference | 1 | 2 | 3 | Notes |
| SF = | 2.77 | 3.30 | 3.02 | 3.20 | Density: 70 |
| 65%/25% | | | | | kg/m³ |
| Hysteresis | 21.04 | 20.46 | 23.87 | 33.54 | GB/T 6343 |
| loss | | | | | |
| 25% ILD | 312.59 | 321.6 | 304.29 | 249.54 | |
| 40% ILD | 440.01 | 489.95 | 439.56 | 365.81 | |
| 65% ILD | 865.22 | 1059.86 | 920.14 | 799.47 | |
| Hardness at | 12.4 | 13.5 | 14.5 | 14.8 | Expressed |
| point 1 | | | | | as push pull |
| Hardness at | 14.2 | 15.6 | 17.5 | 18.5 | force |
| point 2 | | | | | Points 1 to 4 |
| Hardness at | 14.6 | 15.8 | 17.8 | 21.1 | are located |
| point 3 | | | | | at 20, 40, 60 |
| Hardness at | 14.2 | 16 | 18.1 | 21.8 | and 80 mm |
| point 4 | | | | | respectively |

Hysteresis loss was measured according to the method of GB/T 33609.

Compression hardnesses 25% ILD, 40% ILD and 65% ILD were measured according to the method of GB/T 10807.

Density was measured according to the method of GB/T 6343.

### Example 2

In this Example, a real product of a production line was tested. Specifically, foam for a seat was subjected to performance testing, wherein the foam thickness of a test region was 50 mm. Indentation hardness and density were measured by the same method as in Example 1.

The only difference between the standard reference and the seat foam was as follows: The standard reference was the standard reference foam according to Table 3, using a conventional polyether polyether polyol; the foams used in seat foams 1-4 were prepared from the materials specified according to Table 1, and conventional polyether polyol mixtures were used therein. The test results are shown in Table 5.

TABLE 5

| | Standard | Seat | Seat | Seat | Seat | |
|---|---|---|---|---|---|---|
| Performance | reference | foam 1 | foam 2 | foam 3 | foam 4 | Notes |
| SF = | 2.455 | 3.119 | 3.050 | 3.603 | 3.397 | GB/T |
| 65%/25% | | | | | | 6343 |
| 25% ILD | 123.992 | 86.597 | 122.872 | 113.923 | 148.132 | |
| 40% ILD | 166.53 | 128.72 | 182.06 | 175.39 | 224.03 | |
| 65% ILD | 304.44 | 270.09 | 374.75 | 410.53 | 503.14 | |
| Density | 80 | 80 | 80 | 75 | 75 | |
| (kg/m³) | | | | | | |

It can be seen from Table 5 that the seat foams 10 according to the present invention have 40% hardness values of 120-240 N, and the products according to the present invention can all achieve SF>3.

Although the present invention has been described in relative detail with reference to certain Examples and modes of implementation thereof, other modes of implementation are also possible. Thus, the scope of the present invention should not be limited to the specific Examples and modes of implementation thereof included therein.

What is claimed is:

1. A high-rebound molded polyurethane foam with gradient hardness from an upper surface to a lower surface, wherein the high-rebound molded polyurethane foam has uniform density within a thickness from the upper surface to the lower surface, and the high-rebound molded polyurethane foam has a sag factor greater than 3.0, the sag factor being the ratio of 65% compression hardness value to 25% compression hardness value.

2. The high-rebound molded polyurethane foam as claimed in claim 1, wherein the high-rebound molded polyurethane foam is prepared from a formulation comprising modified diphenylmethane diisocyanate and a white material component, the white material comprising a polyol with a molecular weight of 4000-7000 MW and an aid.

3. The high-rebound molded polyurethane foam as claimed in claim 2, wherein the ratio of the modified diphenylmethane diisocyanate to the white material component in the formulation is 45-60:100 (weight percentage).

4. The high-rebound molded polyurethane foam as claimed in claim 2, wherein the polyol is a mixture of polyether polyols.

5. The high-rebound molded polyurethane foam as claimed in claim 4, wherein the mixture comprises two or more different conventional polyether polyols selected from Dongda DEP-5631D, DEP-3500D, EP-330N and EP-3600 and Wanhua F3128, F3135, F3156 and F3170A.

6. The high-rebound molded polyurethane foam as claimed in claim 4, wherein the mixture further comprises a grafted polyether polyol.

7. The high-rebound molded polyurethane foam as claimed in claim 2, wherein the formulation comprises 50 wt %-85 wt % of a conventional polyether polyol and 1 wt %-50 wt % of a grafted polyether polyol.

8. The high-rebound molded polyurethane foam as claimed in claim 2, wherein the aid comprises a catalyst, a chain extender, a silicone oil, a cell-opening agent and water.

9. The high-rebound molded polyurethane foam as claimed in claim 2, wherein the white material component comprises a catalyst, a chain extender, a silicone oil, a cell-opening agent, and water.

10. The high-rebound molded polyurethane foam as claimed in claim 1, wherein the following materials are used in the preparation of the high-rebound molded polyurethane foam:
−0.1 wt %-3 wt % of a catalyst;
−0.1 wt %-3 wt % of a chain extender;
−0.1 wt %-3 wt % of a silicone oil;
−0.5 wt %-5 wt % of water; and
−0.1 wt %-5 wt % of a cell-opening agent.

11. The high-rebound molded polyurethane foam as claimed in claim 1, wherein the foam has a ball rebound ratio of at least 60%.

12. The high-rebound molded polyurethane foam as claimed in claim 1 wherein the uniform density is from 70 kg/m\hat{ }3 to 80 kg/m\hat{ }3.

13. The high-rebound molded polyurethane foam as claimed in claim 1, wherein hardness increases continuously from the upper surface toward the lower surface.

14. The high-rebound molded polyurethane foam as claimed in claim 1, wherein the sag factor is at least 3.1.

15. The high-rebound molded polyurethane foam as claimed in claim 1, wherein the sag factor is at least 3.2.

16. The high-rebound molded polyurethane foam as claimed in claim 1, wherein the foam includes cells comprising large cells and small cells, and wherein a diameter of the large cells at the upper surface is greater than a diameter of the large cells at the lower surface, while the small cells at the upper surface and the small cells at the lower surface have substantially the same diameter.

17. The high-rebound molded polyurethane foam as claimed in claim 1, wherein the diameter of the large cells at the upper surface is from 2.7 mm to 3.0 mm, the diameter of the large cells at the lower surface is from 1.5 mm to 2.4 mm, and the diameter of the small cells is less than 0.9 mm.

18. The high-rebound molded polyurethane foam as claimed in claim 1, wherein the cells at the upper surface are predominantly round and the cells at the lower surface are predominantly regular hexagonal.
